(19) United States
(12) Patent Application Publication
(10) Pub. No.: US 2002/0015009 A1
(43) Pub. Date: Feb. 7, 2002

(54) Transit sign

(76) Inventors: Patrick Harold Davis, Marion, IA (US); Scott Harry, Cedar Rapids, IA (US)

Correspondence Address: LAURA M. SLENZAK, SIEMENS CORPORATION, 186 WOOD AVENUE SOUTH, ISELIN, NJ, 08830, US

(21) Appl. No.: 09/884,860

(22) Filed: Jun. 19, 2001

Related U.S. Application Data
(60) Provisional application No. 60/212,692, filed on Jun. 19, 2000.

(51) Int. Cl. G09G 3/14

(52) U.S. Cl. 345/39

(57) ABSTRACT

A transit sign includes a first housing, an electronic display disposed within the first housing, and an end cap mounted on an end of the first housing. The first housing is configured to link with a second housing having the same cross-section as the first housing. The transit sign displays transit related information on the display.

### REFERENCE TO RELATED APPLICATIONS

This application claims the benefit of U.S. Provisional Application No. 60/212,692, filed Jun. 19, 2000, the entirety of which is herein incorporated by reference.

### BACKGROUND

Transit signs are used to display information to passengers at loading and unloading locations such as bus stops, subway stations, and other train stations. The information displayed on transit signs can be static, such as displaying route numbers and maps, or the information may be ever changing, such as vehicle arrival and departure times, schedule information for different routes, and other timely information desired by passengers.

When the displayed messages on a transit sign are variable, the sign is typically electronic, having a lighting display to display text, such as a multiple row LED display.

A centralized computer system may be used to generate the data to be displayed on various electronic signs throughout a transit system. The information can be relayed to each particular sign via computer network connections, in particular using wireless data transmission. Accordingly, electronic transit signs may include an antenna and modem to transmit and receive data, as well as a microprocessor to decode the data and display the proper information on the sign at the proper times.

Because the typical electronic sign must include such on-board devices as a power supply, microprocessor, and a lighting display, the required housing structure can become complicated. Further, the housing design must take into account such things as weather, animals, and vandals such that the sign is robust enough to perform for substantial periods of time in an outdoor environment. Further, it is desirable to have a sign that is easily scalable such that any desired amount of information can be displayed at a particular sign post, such as when certain locations are served by multiple transit routes.

Conventional signs have difficulties meeting the above-identified needs for various reasons. First, the sign design may not be easily scalable to add additional rows to the sign post if desired because the sign design does not include a scalable mounting configuration. Second, conventional signs can have stability problems when the sign increases in size, particularly in the vertical direction. Third, conventional signs can have problems with bird droppings obscuring the sign because birds tend to perch on the signs. Fourth, conventional signs can have difficulty in preventing water from rain or snow from damaging the interior electronics of the sign, a problem that is typically approached by using gaskets around all possible openings. Fifth, conventional signs have problems with vandal resistance, such as theft of the sign itself, and scratching or writing on the face of the sign. Because electronic signs are more costly than other static transit signs, protection from vandals is an important consideration.

Accordingly, there is a need for a transit sign that is easily scalable. Further, there is a need for a transit sign that is stable when the vertical dimension is increased. Further still, there is a need for a transit sign that has structural protection against bird damage. Further still, there is a need for a transit sign that effectively handles the ingress of rain water. Finally, there is a need for a transit sign that is vandal resistant.

The teachings herein below extend to those embodiments that fall within the scope of the appended claims, regardless of whether they accomplish one or more of the above-identified needs.

### SUMMARY

An exemplary embodiment relates to a transit sign having a first housing, an electronic display disposed within the first housing, and an end cap mounted on an end of the first housing. The first housing is configured to link with a second housing having the same cross-section as the first housing, and the transit sign displays transit related information on the display.

Another exemplary embodiment relates to a vandal resistant electronic transit sign. The vandal resistant electronic transit sign includes a first housing having a mounting plate, an upper leg, and a lower leg, a lens coupled to the housing, two end caps secured to the housing, and a fully enclosed interior space defined by the mounting plate, the upper leg, the lower leg, the lens, and the two end caps. A number of attachment devices are configured to secure the housing to a sign post, wherein the attachment devices are hidden within the interior space of the transit sign.

A further exemplary embodiment relates to a transit information display having a first housing formed as a unitary extrusion and having a mounting plate, an upper leg, and a lower leg. A lens is slidingly engaged with the upper leg and the lower leg. Two end caps are secured to the first housing. The end caps, the mounting plate, the upper leg, the lower leg, and the lens define a fully enclosed interior space. An attachment means concealed within the fully enclosed interior space is accessible by removing at least one of the end caps.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is a front view of a transit sign;

FIG. 2 is a left hand view of a transit sign;

FIG. 3 is a sectional view of a transit sign having two housings and a mounting bracket;

FIG. 4 is an exploded view of the transit sign of FIG. 3;

FIG. 5 is a front view of a transit sign housing; and

FIG. 6 is a front view of a mounting bracket.

### DETAILED DESCRIPTION OF EXEMPLARY EMBODIMENTS

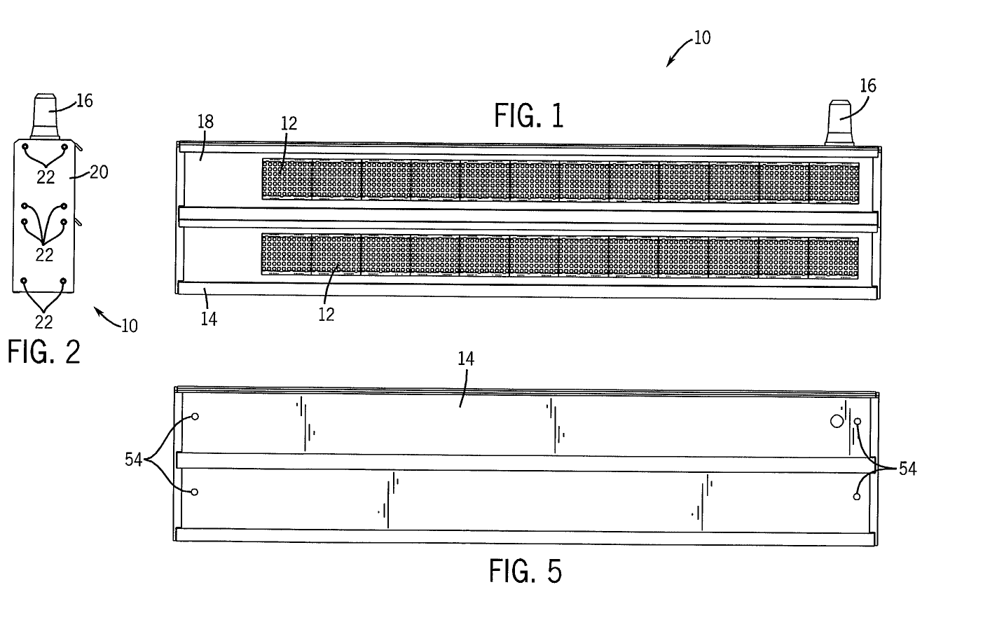

Referring to FIG. 1, a transit sign 10 is depicted according to an exemplary embodiment. Transit sign 10 may include a display, shown as, but not limited to, LED display 12, a housing 14, an antenna 16 designed to receive and transmit wireless communications, and a lens 18 disposed in front of the LED display 12. In an exemplary embodiment, lens 18 is a polycarbonate lens, which may be color coded to enhance readability of the LED display 12.

Referring to FIG. 2, transit sign 10 may also include an end cap 20 attached to transit sign 10 with fasteners, depicted as screws 22. In an exemplary embodiment, transit sign 10 having two rows of LED displays 12 may include an end cap 20 having multiple tamper resistant screws 22.

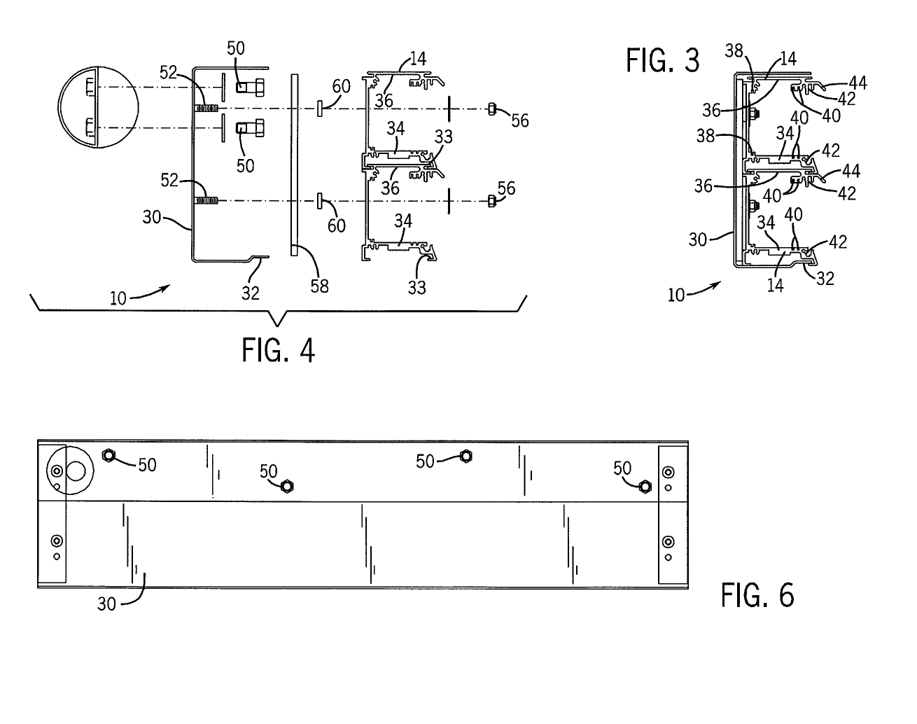

Referring to FIG. 3, sign 10 may further include a mounting bracket 30 designed to support one or more housings 14. Two housings 14 are depicted in FIG. 3 disposed in mounting bracket 30. Mounting bracket 30 further includes tab 32 configured to engage housing 14.

Each housing 14 may include a lower leg 34 and an upper leg 36. In an exemplary embodiment, housing 14 is an extrusion cut to the desired horizontal size of sign 10. In a further exemplary embodiment, housing 14 is an anodized aluminum alloy extrusion.

Upper and lower legs 34, 36 may include slots designed to retain various components such as a power chassis with PC board (not shown) and LED display 12. In the exemplary embodiment shown in FIG. 3, legs 34, 36 include matching rear slots 38 designed to house the power chassis (not shown), two pairs of matching front slots 40 designed to house differing sizes of LED display 12, and a pair of further front slots 42 designed to house lens 18 disposed in front of LED display 12. Upper leg 36 further includes an overhang 44 disposed at an angle extending from the free end of upper leg 36.

Referring to FIG. 4, sign 10 is constructed as follows. Into each housing 14, the various electronic and structural components are first installed such as the power chassis (not shown), microprocessor (not shown), modem (not shown), LED display 12 (see FIG. 1), and lens 18 (see FIG. 1).

Depending on the desired height of sign 10 and number of LED displays 12 desired, multiple housings 14 may be vertically linked together. Upper leg 36 and lower leg 34 are designed to slidingly engage one another to link multiple housings 14. Note that lower leg 34 has a groove 33 configured to either mate with upper leg 36 or bottom tab 32 of bracket 30. After the desired number of housings 14 are linked together, end caps 20 can be installed. End caps 20 are sized to correspond to the number of housings 14. Screws 22 engage with housings 14 to secure end caps to sign 10 (see FIG. 2).

Referring to FIG. 4 and FIG. 6, mounting bracket 30 is installed to sign post (not shown) utilizing any suitable fastener, such as but not limited to, cap screws 50. The size of mounting bracket 30 may be chosen to correspond to the number of housings 14 used for a particular sign 10. Alternatively, housings 14 can be directly installed on sign post (not shown) without the use of mounting bracket 30.

Referring to FIG. 4 and FIG. 5, mounting bracket 30 may include studs 52 arranged to engage corresponding apertures 54 in housing 14. Nuts 56 may be used to secure housing 14 onto studs 52. In other exemplary embodiments, other suitable mechanical attachment means may be used. In another exemplary embodiment, a spacer 58 may be used between mounting bracket 30 and housing 14 and further include washers 60 mounted on studs 52 between spacer 58 and housing 14.

The sign 10 depicted in FIGS. 1-6 and described above includes multiple mechanical features that solve problems related to conventional electronic signs. First, sign 10 is easily scalable to correspond to any desired horizontal or vertical size. With respect to the horizontal dimension, because housing 14 is an extruded member in an exemplary embodiment, the horizontal dimension is easily altered to fit a particular design. Further, multiple housings 14 can be linked in the vertical direction to add multiple LED displays 12 allowing more information to be displayed. The vertical scalability is achieved because lower legs 34 and upper legs 36 are designed to easily link to one another as additional housings 14 are added.

Second, conventional signs can experience problems with stability when the vertical dimension is increased, having problems with wobble in the wind for example. Sign 10 solves the stability problem by including end caps 20, which provide additional stability when multiple housings 14 are stacked. The use of end caps 20 reduces the need to use a multiplicity of set screws in an attempt to lock sign 10 onto signpost (not shown) to solve stability problems.

Third, overhang 44 (see FIG. 3) prevents bird droppings from obscuring the front of sign 10 when birds perch on sign 10, addressing a common problem with conventional transit signs.

Fourth, sign 10 is designed to effectively handle rain water that enters housing 14. Conventional signs address the problem of water ingress by attempting to completely seal the interior from the elements. However, due to prolonged exposure to the environment, the gaskets and other sealants used on conventional signs tend to degrade over time and result in water ingress. Sign 10 is designed to address this problem by creating a pathway for water to exit sign 10 in the event that water enters housing 14. Referring to FIG. 3, slot 42 in lower leg 34 is larger than required to house lens 18. Accordingly, slot 42 has room to serve as a channel to direct water from the interior of housing 14 out of sign 10 through end caps 20. Accordingly, if water does enter sign 10, the interior electronics will not be damaged because the water drains using slot 42 as a channel.

Fifth, sign 10 is designed to be vandal resistant. The resistance to vandals is incorporated into several aspects of sign 10. Referring to FIG. 1, FIG. 4, and FIG. 5, LED display 12 and end caps 20 completely block the view of the interior of housing 14 such that it is not possible to ascertain how housing 14 is attached to the bracket 30 or signpost (not shown). In order to install sign 10, one of the two end caps 20 is first removed. By removing one of the end caps 20, the installer can reach into housing 14 through the opening former occupied the first end cap 20 and install nut 56 onto stud 52 because apertures 54 are disposed near the end caps 20. Once nuts 56 are secured on one side of sign 10, lens 18 and LED display 12, and the power chassis (not shown) may be shifted out of housing 14 through the space formerly occupied by the removed end cap 20 by sliding the components in slots 38, 40, and 42. By sliding LED display 12, lens 18, and power chassis (not shown) to one side, the installer gains access through the front of sign 10 to install nuts 56 on studs 52 located on the opposite side of sign 10, completing the installation of housing 14 to mounting bracket 30. Lens 18, LED display 12, and the power chassis are then shifted back to their operational position and end cap 20 is installed using tamper resistant screws 22. In order for a vandal to determine how sign 10 is installed, and remove or damage sign 10, the vandal would have to remove a multitude of tamper resistant screws 22 to determine what resides inside sign 10, thus dissuading the vandal from further action. Further, referring to FIG. 3 and FIG. 4, the engagement of tab 32, of bracket 30 with lower leg 34 of housing 14 in addition to the placement of end caps 20 eliminates any gaps through which a vandal could insert a pry bar to attempt to pry sign 10 apart. Further still, the use of slots 42 to house lens 18 permits easy removal and replacement of lens 18 if necessary due to damage caused by vandals.

Sixth, because housing 14 is an extrusion, the overall cost of sign 10 is reduced by not requiring a custom build of housing 14 out of sheet metal or other suitable material. Further, because the additional housings 14 used to expand the vertical dimension of sign 10 have the same cross-section, the number of different component parts of sign 10 is reduced, further reducing the cost relative to conventional signs.

While the detailed drawings, specific examples and particular formulations given describe exemplary embodiments, they serve the purpose of illustration only. The configurations shown and described may differ depending on the chosen performance characteristics and physical characteristics of sign 10. The sign shown and described is not limited to the precise details and conditions disclosed. Furthermore, other substitutions, modifications, changes, and omissions may be made in the design, operation conditions and arrangement of the exemplary embodiments without departing from the scope of the invention as expressed in the appended claims.

What is claimed is:

1. A transit sign, comprising:
a first housing,
an electronic display disposed within the first housing; and
an end cap mounted on an end of the first housing;
wherein the first housing is configured to link with a second housing having the same cross section as the first housing;
wherein the transit sign displays transit-related information on the display.

2. The transit sign of claim 1, wherein the transit sign is used at a bus stop.

3. The transit sign of claim 1, wherein the transit sign is used at a train station.

4. The transit sign of claim 1, wherein the display is an LED display.

5. The transit sign of claim 1, wherein the second housing is linked to the first housing.

6. The transit sign of claim 5, further comprising a third housing linked to the second housing.

7. The transit sign of claim 6, further comprising a fourth housing linked to the third housing.

8. The transit sign of claim 1, wherein the first housing is an extrusion.

9. The transit sign of claim 1, wherein the transit-related information is chosen from the group consisting of schedules, route information, and the time remaining before a transit vehicle arrives.

10. The transit sign of claim 1, wherein the first housing comprises a upper leg and a lower leg, the upper and lower legs including slots configured to retain a number of sign components.

11. The transit sign of claim 10, further comprising an overhang extending from the upper leg, wherein the overhang is configured to shield the lens from material falling from a position above the lens.

12. The transit sign of claim 10, further comprising a channel disposed in the lower leg of the first housing, wherein the channel is configured to drain water from within the first housing out of the transit sign.

13. The transit sign of claim 12, wherein the channel also houses the lens.

14. The transit sign of claim 10, wherein the slots are matched in order to retain the sign components.

15. The transit sign of claim 14, wherein the sign components are chosen from the group consisting of a lens, a power chassis, a PC board, and an LED display.

16. The transit sign of claim 1, further comprising a mounting bracket, the mounting bracket configured to support the first housing.

17. The transit sign of claim 16, wherein the mounting bracket includes a number of studs configured to engage a number of corresponding apertures in the first housing.

18. The transit sign of claim 16, wherein the mounting bracket is sized to support a plurality of housings.

19. The transit sign of claim 16, wherein the mounting bracket includes a tab disposed within a corresponding groove in the first housing.

20. The transit sign of claim 1, further comprising a number of attachment devices securing the first housing on to one of a mounting bracket and a signpost, wherein the attachment devices are disposed within the first housing.

21. The transit sign of claim 20, wherein the attachment devices comprise a number of studs and a number of corresponding nuts.

22. A vandal resistant electronic transit sign, comprising:
a first housing having a mounting plate, an upper leg, and a lower leg;
a lens coupled to the first housing;
two end caps secured to the first housing;
a fully enclosed interior space defined by the mounting plate, the upper leg, the lower leg, the lens, and the two end caps; and
a number of attachment devices configured to secure the first housing to a signpost, wherein the attachment devices are hidden within the interior space of the transit sign.

23. The vandal resistant electronic transit sign of claim 22, wherein the end caps are mounted to the first housing with a plurality of tamper resistant screws.

24. The vandal resistant electronic transit sign of claim 22, further comprising a second housing linked to the first housing.

25. The vandal resistant electronic transit sign of claim 24, further comprising a third housing linked to the second housing.

26. The vandal resistant electronic transit sign of claim 25, further comprising a fourth housing linked to the third housing.

27. The vandal resistant electronic transit sign of claim 22, wherein the first housing comprises a upper leg and a lower leg, the upper and lower legs including slots configured to retain a number of sign components.

28. The vandal resistant electronic transit sign of claim 27, wherein the slots are matched in order to retain the sign components.

29. The vandal resistant electronic transit sign of claim 22, further comprising a mounting bracket, the mounting bracket configured to support the first housing.

30. The vandal resistant electronic transit sign of claim 29, wherein the mounting bracket includes a number of studs configured to engage a number of corresponding apertures in the first housing

31. The vandal resistant electronic transit sign of claim 30, wherein the mounting bracket includes a tab disposed within a corresponding groove in the first housing.

32. A transit information display, comprising:
a first housing formed as a unitary extrusion and having a mounting plate, an upper leg, and a lower leg;
a lens slidingly engaged with the upper leg and the lower leg;
two end caps secured to the first housing, the two end caps, the mounting plate, the upper leg, the lower leg, and the lens defining a fully enclosed interior space; and
an attachment means concealed within the fully enclosed interior space and accessible by removing at least one of the end caps.

33. The transit information display of claim 32, further comprising a second housing linked to the first housing.

34. The transit information display of claim 33, further comprising a third housing linked to the second housing.

35. The transit information display of claim 34, further comprising a fourth housing linked to the third housing.

36. The transit information display of claim 32, wherein the upper leg and lower leg have matched slots to retain the lens.
